(19) United States
(12) Patent Application Publication
(10) Pub. No.: US 2012/0277898 A1
(43) Pub. Date: Nov. 1, 2012

(54) PROCESSING SYSTEM AND PROCESSING METHOD

(75) Inventors: Yasuhiro Kawai, Hagagun (JP); Kensaku Kaneyasu, Hagagun (JP); Kazuhiko Yamaashi, Hagagun (JP); Toshihiro Murakawa, Hagagun (JP)

(73) Assignee: HONDA MOTOR CO., LTD., Tokyo (JP)

(21) Appl. No.: 13/520,662

(22) PCT Filed: Dec. 10, 2010
(86) PCT No.: PCT/JP2010/072246

§ 371 Date: Jul. 5, 2012

(30) Foreign Application Priority Data
Jan. 6, 2010 (JP) 2010-001048

(51) Int. Cl. G05B 19/18

(52) U.S. Cl. 700/114

(57) ABSTRACT

Disclosed are a processing system and a processing method such that the production cost in a workpiece processing line is reduced and that a workpiece is processed efficiently. A robot 11 has an arm 23 at the tip of which the processing machine 12 is installed, and a robot base 22 on which the arm 23 is installed. The robot base 22 is installed on a robot movement mechanism 14, and said robot movement mechanism 14 moves the robot 11. A robot control device 16 performs movement control of the arm 23, and also executes movement control on the robot movement mechanism 14. By way of movement control of the robot movement mechanism 14, the robot control device 16 executes control wherein the robot 11 is moved independently of the continuous conveyance of the workpiece 2 by the continuous conveying mechanism 20.

### TECHNICAL FIELD

The present invention relates to a processing system and a processing method for processing workpieces that are continuously conveyed. Specifically, it relates to a processing system and processing method capable of lowering production cost and processing workpieces efficiently.

### BACKGROUND ART

Conventionally, a continuous conveying mechanism that continuously conveys workpieces, and a processing device (robot or the like) that carries out a processing action on the workpiece have been provided in the processing lines that process bodies of vehicles or the like as workpieces (for example, refer to Japanese Unexamined Patent Application, Publication No. H6-190662).

An arm (multi-joint manipulator or the like), and a processing machine (end effector) mounted to the leading end thereof are provided in such a processing device.

The arm of the processing device causes the leading end of the processing machine to approach an objective position of a processing target of the workpiece by making a movement action. Then, the processing machine of the processing device makes a processing action such as bolting or welding on the processing target at the objective position.

As a conventional technique realizing processing actions by way of such a processing device, a technique has been known of providing, on the production line, a processing area in which a workpiece is detached from the continuous conveying mechanism and allowed to temporarily stop (hereinafter referred to as “temporary stop technique”). In a case of the temporary stop technique being adopted, the arm of the processing device initiates the movement action to cause the leading end of the processing machine to move to an objective position, after the workpiece has temporarily stopped in the processing area.

In addition, as another conventional technique realizing processing actions by way of a processing device, a technique has been known of providing a movement mechanism to move the base of the processing device (robot base), and synchronizing the movement of the base of the processing device by this movement mechanism with the movement of the workpiece by the continuous conveying mechanism (hereinafter referred to as “synchronous movement technique”). In a case of the synchronous movement technique being adopted, the arm of the processing device initiates the movement action to move the processing machine to the objective position, after the movements of the base of the processing device and the workpiece have come to be synchronous.

### DISCLOSURE OF THE INVENTION

### Problems to be Solved by the Invention

However, there is a problem in that the production cost is high in a production line in which such conventional techniques such as the temporary stop technique and synchronous movement technique are adopted (hereinafter referred to as “conventional production line”).

For example, in a case of adopting the temporary stop technique, the mechanical cost for detaching the workpiece from the continuous conveying mechanism is high. In addition, in a case of adopting the synchronous movement technique, the mechanical cost for making the workpiece and the base of the processing device move synchronously is high, for example.

Furthermore, with a conventional production line, there is also the problem of the processing actions of the processing device being inefficient. For example, in a case of adopting the temporary stop technique, a long time period is required until detaching the workpiece from continuous conveyance and allowing to temporarily stop in a processing area.

Furthermore, in a case of adopting the synchronous movement technique, a long time period is required until making the workpiece and base of the processing device move synchronously, for example. More specifically, in such cases that achieve synchronized movement by docking the continuous conveying mechanism and movement mechanism, a long time period is required in this docking action. The processing action of the processing device being first initiated after a long time period has elapsed in this way means that the processing action of the processing device is inefficient from a time perspective.

Furthermore, in a case of adopting the synchronous movement technique, if defining the base position of the processing device as a reference position, making the movement of the workpiece and the base of the processing device synchronous means that the reference position also moves synchronously with the workpiece. In view of this, the range in which one processing device can perform processing (range of movement) is only within the movement range of this arm on the entire workpiece, viewed from the reference position. Therefore, in a case of the entire workpiece being large compared to the movement range of the arm, a plurality of processing devices must be provided. Providing a plurality of processing devices in this way means that the processing action per processing device is inefficient, and furthermore, means that the aforementioned production cost will increase.

The present invention has an object of providing a processing system and processing method for processing continuously conveyed workpieces that are capable of reducing the production cost and efficiently processing workpieces.

### Means for Solving the Problems

A processing system according to the present invention (e.g., the processing system 1 of the embodiment) that performs predetermined processing on a workpiece (e.g; the workpiece 2 of the embodiment) that is continuously conveyed, includes:

a continuous conveying mechanism (e.g., the continuous conveying mechanism 20 of the embodiment) that causes the workpiece to be continuously conveyed;

a processing device (e.g., the processing machine 12 and arm 23 of the robot 11 of the embodiment) that performs a predetermined processing action on the workpiece;

a base (e.g., the robot base 22 of the embodiment) to which the processing device is mounted;

a movement mechanism (e.g., the robot movement mechanism 14 of the embodiment) to which the base is mounted, and causing the base to move; and

a control device (e.g., the robot control device 16 of the embodiment) that executes, as movement control on the movement mechanism, control to cause the base to move independently from continuous conveyance of the workpiece by way of the continuous conveying mechanism.

According to the present invention, since the base of the processing device can be made to move by the movement mechanism, the necessity of specially providing a processing area for decoupling the workpiece from continuous conveyance and allowing to temporarily stop is eliminated. Furthermore, since the movement mechanism can cause the base to move independently from the continuous conveyance of the workpiece by the continuous conveying mechanism, the necessity for synchronizing the movements of the base and workpiece is eliminated in particular.

The mechanical costs that have been conventionally required as production costs of a production line of the workpieces, e.g., the mechanical cost for decoupling the workpiece from continuous conveyance, and the mechanical cost for making the workpiece and the base of the processing device both move synchronously, thereby become unnecessary. Therefore, it becomes possible to realize a processing line of the workpieces with low cost compared to conventionally.

In addition, by combining the movement control of the processing device and movement control for the movement mechanism (movement control of the base), it is possible to make the leading end of the processing device move relative to an objective position of the workpiece. Therefore, compared with conventionally, the operating range of one processing device expands; therefore, the degrees of freedom in processing actions of the processing device improve, and it becomes possible to perform much more efficient processing.

In this case, it is preferable to further include:

a first detection sensor (e.g., the camera 13 of the embodiment) that is disposed at the processing device, and at least detects a position of a processing target of the workpiece (e.g., the aiming position 41 of the embodiment); and

a second detection sensor (e.g., the remote position sensors 18r, 19r of the embodiment) that is disposed to be separated from the processing device, and detects a position of either of the processing device or the first detection sensor,

in which the control device further

obtains deviation of an absolute position of a leading end of the processing device relative to an absolute position of the processing target, using detection results of each of the first detection sensor and the second detection sensor, and

controls movement action of the processing device based on the deviation.

According to the present invention, the deviation used in movement control of the processing device is calculated in the coordinate system expressing the entire space in which the workpiece is arranged, i.e. the world coordinate system, based on the observation information in the vicinity of the leading end of the processing device or in the vicinity of the processing target (detection results of the first detection sensor and the second detection sensor). This means that the deviation used in movement control of the processing device can be obtained without dependence on the position of the base of the processing device.

Therefore, it becomes possible for the control device to appropriately execute positioning control to make the leading end of the processing machine match the objective processing target, at whatever position the base of the processing device is present.

The processing method of the present invention is a method corresponding to the aforementioned processing system of the present invention. Therefore, it is able to exert various effects similar to the aforementioned processing system of the present invention.

### Effects of the Invention

According to the present invention, since the base of the processing device can be made to move, the necessity of specially providing a processing area for decoupling the workpiece from continuous conveyance and allowing to temporarily stop is eliminated. Furthermore, since it is possible to cause the base to move independently from the continuous conveyance of the workpiece, the necessity for synchronizing the movements of the base and workpiece is eliminated in particular.

The mechanical costs that have been conventionally required as production costs of a production line of the workpieces, e.g., the mechanical cost for decoupling the workpiece from continuous conveyance, and the mechanical cost for making the workpiece and the base of the processing device both move synchronously, thereby become unnecessary. Therefore, it becomes possible to realize a processing line of the workpieces with low cost compared to conventionally.

In addition, by combining the movement control of the processing device and movement control for the movement mechanism (movement control of the base), it is possible to make the leading end of the processing device move relative to an objective position of the workpiece. Therefore, compared with conventionally, the operating range of one robot expands; therefore, the degrees of freedom in processing actions of the processing device connected to one robot improve, and it becomes possible to perform more efficient processing than conventionally.

### BRIEF DESCRIPTION OF THE DRAWINGS

FIG. 1 is a side view showing an external outline configuration of a processing system according to an embodiment of the present invention;

FIG. 2 is a functional block diagram showing a functional configuration example of a robot control device of the processing system in FIG. 1;

FIG. 3 is a block diagram showing a configuration example of the hardware of the robot control device in FIG. 2;

FIG. 4 is a flowchart showing a flow example of a processing process by the robot control device in FIG. 2 or the like; and

FIG. 5 is a flowchart showing a detailed flow example of a position deviation calculation processing in the processing process of FIG. 4.

### EXPLANATION OF REFERENCE NUMERALS

1 processing system

2 workpiece

11 robot

12 processing machine

13 camera

14 robot movement mechanism

15 robot drive device

16 robot control device

17 processing-machine control device

18s remote position sensor

19s remote position sensor

20 continuous conveying mechanism

22 robot base

23 arm

41 aiming position

51 camera-absolute-position acquisition unit

52 processing target recognition unit

53 aiming position calculation unit

54 arm-absolute-position acquisition unit

55 processing-machine leading-end absolute position calculation unit

56 robot position control unit

### PREFERRED MODE FOR CARRYING OUT THE INVENTION

Hereinafter, an embodiment of the present invention will be explained based on the drawings.

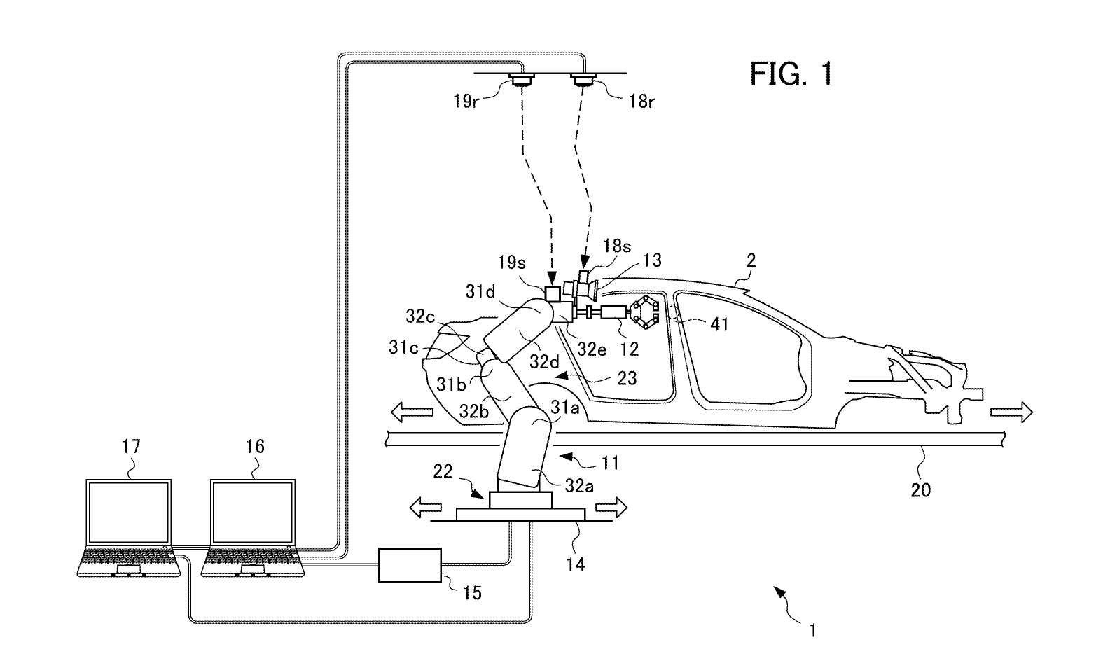

FIG. 1 is a side view showing an external outline configuration of a processing system 1 according to the embodiment of the present invention.

For example, the processing system 1 is provided in a prescribed manner in a continuous conveyance line in the production line of automobiles, and with the body or the like of automobiles being continuously conveyed as a workpiece 2, performs various processes such as welding and bolting on the workpiece 2.

The processing system 1 includes a robot 11, processing machine 12, camera 13, robot movement mechanism 14, robot drive device 15, robot control device 16, processing-machine control device 17, remote position sensor 18r, remote position sensor 19r, and continuous conveying mechanism 20.

The robot 11 includes a base 22 (hereinafter referred to as “robot base 22”) mounted to the robot movement mechanism 14, and an arm 23 that is configured by a multi-joint manipulator that is rotatably mounted to this robot base 22.

The arm 23 includes joints 31a to 31d, coupling members 32a to 32e, servo-motors (not illustrated) that cause each joint 31a to 31d to rotate, and a detection unit (not illustrated) that detects various states such as the position, speed, and current of the servo-motor.

The overall actions of the arm 23, i.e. overall actions of the robot 11, are realized according to a combination of the rotational actions of each joint 31a to 31d by way of the respective servo-motors, and movement actions of each coupling member 32a to 32e working together with these rotational actions.

The processing machine 12 is mounted as an end effector to the leading end of the coupling member 32e of the arm 23, and the leading end moves up to a position of the processing target of the workpiece 2 (hereinafter referred to as “aiming position”), e.g., the aiming position 41 in FIG. 1, accompanying the movement actions of the arm 23. Then, the processing machine 12 carries out various processing such as welding and bolting on the processing target at the aiming position 41, in accordance with the control of the processing-machine control device 17.

In other words, it can be understood as the present embodiment configuring the processing device by the arm 23 of the robot 11 and the processing machine 12. In a case of understanding in this way, the base on which the processing device is mounted is the robot base 22.

The camera 13 is mounted to be fixed to a peripheral part of the connection member 32e of the arm 23, so as to be able to capture an image of a leading end of the processing machine 12 as a center of an angle of view.

The camera 13 captures an image that is within the range of the angle of view, in the direction of the leading end of the processing machine 12. Hereinafter, the image captured by the camera 13 is referred to as “captured image”.

By conducting image processing on image data of a captured image, the robot control device 16 described later can easily obtain the coordinates of an aiming position 41 in a coordinate system (hereinafter referred to as “camera coordinate system”) with the position of the camera 13 defined as the origin. It should be noted that the coordinates of the aiming position 41 of the camera coordinate system are referred to as “camera coordinate position of aiming position 41”.

Furthermore, by conducting image processing on image data of a captured image, the robot control device 16 can detect the attitude, level difference, gap, etc. as the shape of a processing target included in the captured image.

In other words, the camera 13 has a function of a measurement sensor that measures the aiming position 41.

The robot movement mechanism 14 causes the robot base 22 to move under the control of the robot control device 16 described later, independently (asynchronously) from the continuous conveyance of workpieces 2 by the continuous conveyance mechanism 20, substantially in parallel to the conveyance direction of workpieces 2 (white arrow direction in FIG. 1), for example.

A command to cause the robot 11 to move to an objective position (hereinafter referred to as “movement command”) is provided from the robot control device 16 described later to the robot drive device 15. Therefore, the robot drive device 15 performs torque (current) control on each servo motor equipped to the arm 23, using the detection value of each detector equipped to the arm 23 as feedback values, in accordance with the movement command. The overall motion of the arm 23, i.e. overall motion of the robot 11, is thereby controlled.

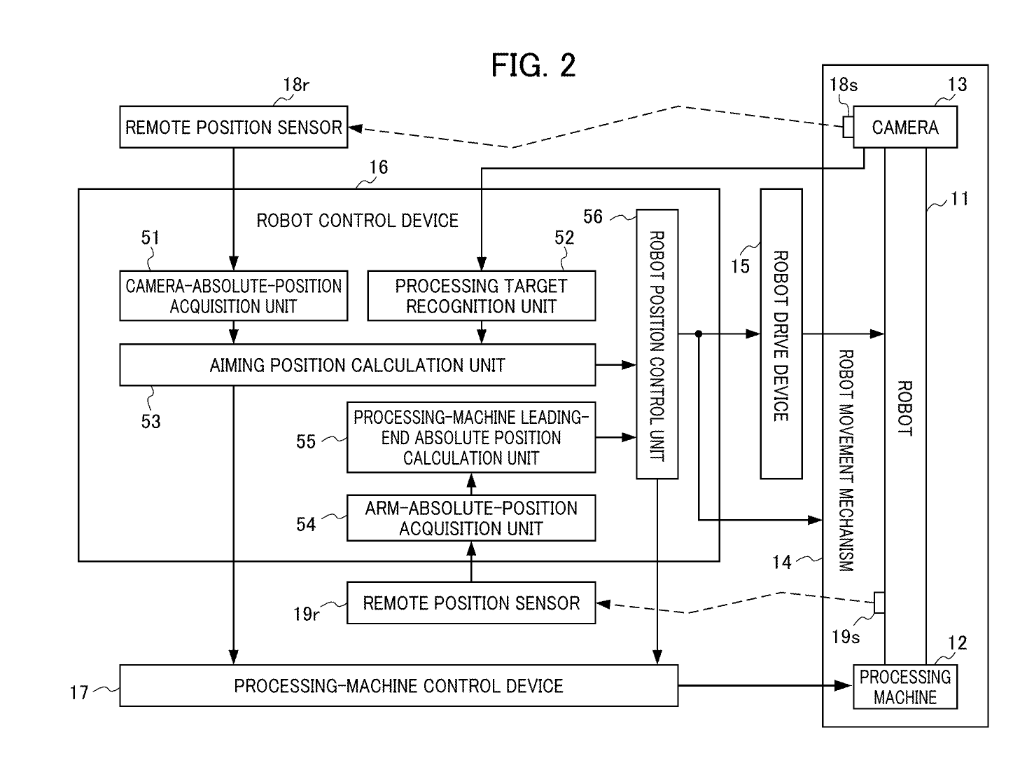

The robot control device 16 controls movement actions of the robot 11 and the robot movement mechanism 14. Details of the robot control device 16 will be described later while referencing FIG. 2.

The processing-machine control device 17 executes control to change the processing conditions in the processing machine 12, and control of processing actions of the processing machine 12. Processing conditions refer to conditions such as the current required in welding in a case of the processing machine 12 being a welding machine, for example.

The remote position sensor 18r detects, as the coordinates of a world coordinate system, the position of a detection object 18s provided as a pair.

The world coordinate system is a coordinate system that expresses the entire space in which the workpieces 2 are arranged, i.e. entire space of the continuous conveyor line of automobiles. It should be noted that the coordinates shown according to the world coordinate system are referred to as “absolute position” hereinafter.

In the present embodiment, the remote position sensor 18r detects, and provides to the robot control device 16, the absolute position of the detection object 18s mounted to the remote camera 13 (hereinafter referred to as “camera absolute position”). It should be noted that the purpose of the camera absolute position will be described later while referencing FIG. 2.

The remote position sensor 19r detects the absolute position of a detection object 19s provided as a pair. In the present embodiment, the remote position sensor 19r detects, and provides to the robot control device 16, the absolute position of the detection object 19s mounted to the connection member 32e of the arm 23 (hereinafter referred to as “arm absolute position”). It should be noted that the purpose of the arm absolute position will be described later while referencing FIG. 2.

The continuous conveying mechanism 20 causes the workpiece 2 to be continuously conveyed in a fixed direction: the white arrow direction in FIG. 1 in the present embodiment. Herein, a noteworthy point in the present embodiment is the point that the workpiece 2 is processed while being continuously conveyed by the continuous conveying mechanism 20.

According to this point, the requirement of providing to the processing system 1 a processing area to process a workpiece after being detached from the continuous conveyance and made to temporarily stop is eliminated in particular.

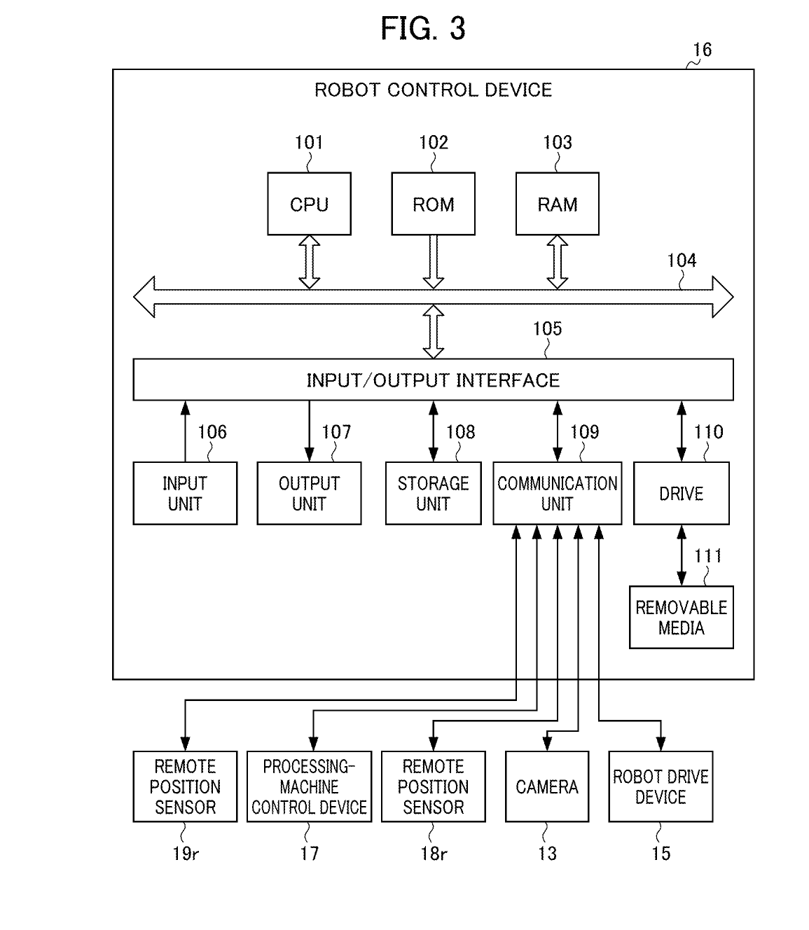

Next, the robot control device 16 will be explained in further detail while referencing FIGS. 2 and 3.

FIG. 2 is a functional block diagram showing a functional configuration example of the robot control device 16.

The robot control device 16 includes a camera-absolute-position acquisition unit 51, processing target recognition unit 52, aiming position calculation unit 53, arm-absolute-position acquisition unit 54, processing-machine leading-end absolute position calculation unit 55, and robot position control unit 56.

The camera-absolute-position acquisition unit 51 acquires, and provides to the aiming position calculation unit 53, the camera absolute position detected by the remote position sensor 18r.

The processing target recognition unit 52 recognizes the camera coordinate value, attitude, level differences, gaps, etc. of the aiming position 41 for the processing target, from in the captured image based on the image data outputted from the camera 13. The recognition results of the processing target recognition unit 52 are provided to the aiming position calculation unit 53.

The aiming position calculation unit 53 calculates the absolute position of the aiming position 41, using the camera absolute position from the camera-absolute-position acquisition unit 51 and the camera coordinate values of the aiming position 41 from the processing target recognition unit 52.

In other words, the aiming position calculation unit 53 calculates the absolute position of the aiming position 41, by adding the camera coordinate value of the aiming position 41 as an offset amount to the camera absolute position.

In other words, the aiming position calculation unit 53 converts the coordinate system expressing the aiming position 41 from the camera coordinate system to the world coordinate system, using the camera absolute position, which is the detection result of the remote position sensor 18r.

The absolute position of the aiming position 41 calculated by the aiming position calculation unit 53 is provided to the robot position control unit 56. It should be noted that, in the recognition results of the processing target recognition unit 52, the attitude, level differences, gaps, etc. of the processing target are provided to the processing-machine control device 17 as parameters for deciding processing conditions.

The arm-absolute-position acquisition unit 54 acquires, and provides to the processing-machine leading-end absolute position calculation unit 55, the arm absolute position detected by the remote position sensor 19r.

The processing-machine leading-end absolute position calculation unit 55 calculates the absolute position of the leading end of the processing machine 12 (hereinafter referred to as “absolute position of processing-machine leading end”), based on this arm absolute position.

In other words, the coordinates of the position of the leading end of the processing machine 12 (hereinafter referred to as “arm-leading-end coordinate value of processing machine leading end”) in the coordinate system with the arm absolute position as the origin (hereinafter referred to as “arm-leading-end coordinate system”) can be easily calculated based on the form of the processing machine 12 obtained in advance, and the attitude of the leading-end part of the arm 23. Therefore, the processing-machine leading-end absolute position calculation unit 55 calculates the absolute position of the processing-machine leading end by adding the arm-leading-end coordinate value of the processing-machine leading end as an offset amount to the arm absolute position.

In other words, the aiming position calculation unit 53 converts the coordinate system expressing the position of the leading end of the processing machine 12 from the arm-leading-end coordinate system to the world coordinate system, using the arm absolute position, which is the detection result of the remote position sensor 19r.

The absolute position of the processing-machine leading end calculated by the aiming position calculation unit 53 is provided to the robot position control unit 56.

The robot position control unit 56 obtains the deviation of the absolute position of the processing-machine leading end provided from the processing-machine leading-end absolute position calculation unit 55 relative to the absolute position of the aiming position 41 provided from the aiming position calculation unit 53, and controls the respective movement actions of the robot 11 (more precisely, the arm 23) and the robot movement mechanism 14 (more precisely, the robot base 22), so as to eliminate this deviation.

In the present embodiment, the robot position control unit 56 executes movement control of the robot movement mechanism 14 when the deviation is great (e.g., at least a predetermined threshold), and executes movement control of the robot 11 when the deviation is small (e.g., less than a predetermined threshold).

As movement control of the robot 11 in the present embodiment, the robot position control unit 56 executes control to generate, and provide to the robot drive device 15, a movement command based on the aforementioned deviation. The robot drive device 15 to which the movement command is provided causes the robot 11 to move towards a processing target of the aiming position 41, in accordance with this movement command, as described above.

In other words, visual servo control using, as feedback information, the absolute position of the processing-machine leading end obtained from the captured image of the camera 13 is employed as the movement control of the robot 11 in the present embodiment.

A result of such visual servo control, when the aforementioned deviation substantially agrees, the visual servo control by the robot position control unit 56 stops, and the movement action of the robot 11 stops.

Then, the robot position control unit 56 notifies that positioning has ended to the processing-machine control device 17. If the processing conditions are being satisfied when this notification is received, the processing-machine control device 17 controls the processing actions of the processing machine 12. In other words, the processing machine 12 makes the processing actions such as bolting and welding on the processing target at the aiming position 41.

Noteworthy herein is that all of the information used in order to obtain the deviation necessary in the control of the robot position control unit 56, i.e. all of the absolute position of the aiming position 41 and the absolute position of the processing-machine leading end, can be obtained from observation information of the vicinity of the leading end of the processing machine 12 or in the vicinity of the aiming position 41.

More specifically, the absolute position of the aiming position 41 is obtained from the detection information of the remote position sensor 18r (camera absolute position), which is one kind of the observation information in the vicinity of the leading end of the processing machine 12, and the image-capture information of the camera 13 (camera coordinate values of the aiming position 41 obtained from the captured image), which is one kind of the observation information in the vicinity of the aiming position 41.

On the other hand, the absolute position of the processing-machine leading end is obtained from the detection information of the remote position sensor 19r (camera absolute position), which is another kind of observation information in the vicinity of the leading end of the processing machine 12.

In other words, all of the absolute position of the aiming position 41 and the absolute position of the processing-machine leading end can be obtained without depending on the position of the robot base 22.

Herein, it is easily possible to know in advance to which direction of the world coordinate system a predetermined direction of the coordinate system in which the central position of the robot base 22 is the origin (hereinafter referred to as “robot coordinate system”) corresponds. Therefore, in a case of such an understanding being made, the leading end of the processing machine 12 can be easily made to match the aiming position 41, by the camera 13 and the remote position sensors 18r, 19r observing the vicinity of the leading end of the processing machine 12 and the vicinity of the aiming position 14, and the robot position control unit 56 controlling the movement actions of the robot 11 and the robot movement mechanism 14 using this observation information.

In other words, the robot position control unit 56 can appropriately execute positioning control to make the leading end of the processing machine 12 match the objective aiming position 41, at whatever position the robot base 22 is present.

A functional configuration example of the robot control device 16 has been explained in the foregoing. Next, a hardware configuration example of the robot control device 16 having such a functional configuration will be explained.

FIG. 3 is a block diagram showing a configuration example of the hardware of the robot control device 16.

The robot control device 16 includes a CPU (Central Processing Unit) 101, ROM (Read Only Memory) 102, RAM (Random Access Memory) 103, a bus 104, an input/output interface 105, an input unit 106, an output unit 107, a storage unit 108, a communication unit 109, and a drive 110.

The CPU 101 executes various processing in accordance with programs recorded in the ROM 102. Alternatively, the CPU 101 executes various processing in accordance with programs loaded from the storage unit 108 to the RAM 103. The data and the like necessary upon the CPU 101 executing the various processing are also stored in the RAM 103 as appropriate.

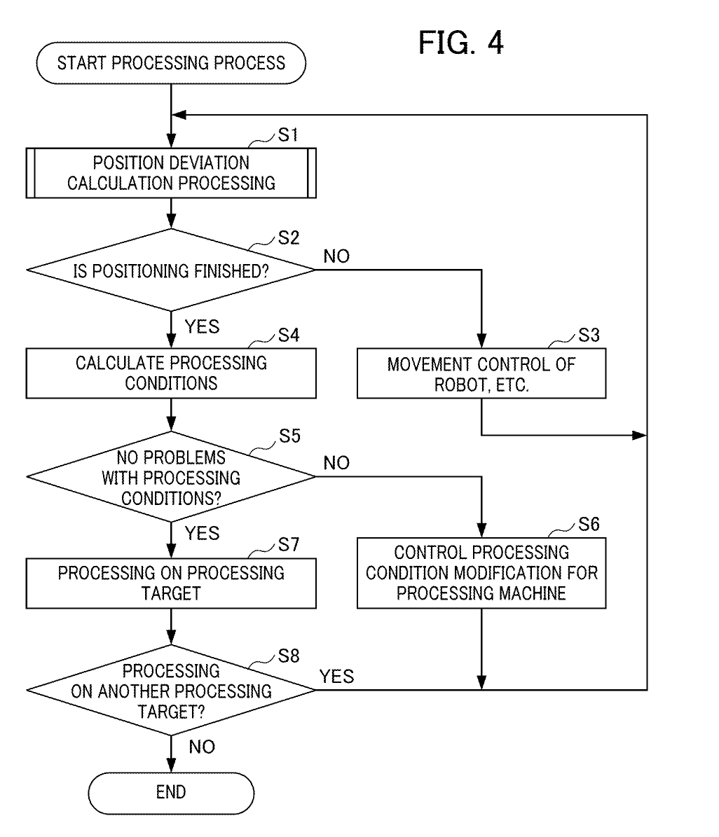

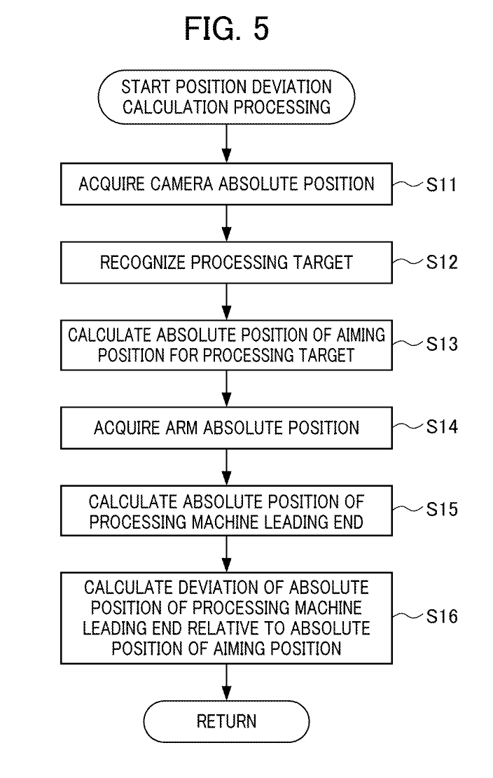

For example, in the present embodiment, a program for executing the respective functions of the aforementioned camera-absolute-position acquisition unit 51 to robot position control unit 56 in FIG. 2 are stored in the ROM 102 or storage unit 108. Therefore, the CPU 101 can realize the respective functions of the camera-absolute-position acquisition unit 51 to robot position control unit 56 by executing processing in accordance with this program. It should be noted that an example of processing according to such a program will be described later while referencing the flowcharts of FIGS. 4 and 5.

The CPU 101, ROM 102 and RAM 103 are connected to each other via the bus 104. The input/output interface 105 is also connected to this bus 104.

The input unit 106 configured by a keyboard and the like, the output unit 107 configured by a display device, speakers and the like, the storage unit 108 configured by a hard disk or the like, and the communication unit 109 are connected to the input/output interface 105.

The communication unit 109 controls each of communication carried out with the camera 13, communication carried out with the robot drive device 15, communication carried out with the processing-machine control device 17, communication carried out with the remote position sensor 18r, communication carried out with the remote position sensor 19r, and communication carried out with other devices (not illustrated) via a network including the internet. It should be noted that these communications are defined as wired communications in the example of FIG. 1; however, they may be wireless communications.

The drive 110 is connected to the input/output interface 105 as necessary, and removable media 111 consisting of magnetic disks, optical disks, magneto-optical disks, semiconductor memory, or the like is installed therein as appropriate. Then, programs read from these are installed in the storage unit 108 as necessary.

FIG. 4 is a flowchart showing an example of the flow of a processing process executed by the robot control device 16 and processing-machine control device 17 having such configurations.

Herein, the processing process refers to a sequence of control processing required from the leading end of the processing machine 12 moving to the aiming position 41 by way of the movement actions of the robot 11 and robot movement mechanism 14, until the processing machine 12 performs a processing action at the aiming position 41.

In the illustration of FIG. 4, the executor of the processing handled by the robot control device 16 is set to be the CPU 101 in FIG. 3. In addition, although the executor of the processing handled by processing-machine control device 17 should be a CPU or the like (not illustrated) equipped to the processing-machine control device 17, for of explanation herein, it is set to be the processing-machine control device 17.

In Step S1, the CPU 101 executes a sequence of processing until obtaining the deviation of the absolute position of the processing-machine leading end relative to the absolute position of the aiming position 41. It should be noted that this sequence of processing is hereinafter referred to as “position deviation calculation processing”. Details of position deviation calculation processing will be described later while referencing FIG. 5.

In Step S2, the CPU 101 determines whether positioning has ended. Although the determination technique of Step S2 is not particularly limited, a technique is adopted in the present embodiment that determines that positioning has ended when the deviation calculated in the position deviation calculation processing of Step S1 has become less than a fixed distance.

Therefore, in a case of the deviation calculated in the position deviation calculation processing of Step S1 being at least a fixed distance, it is determined as being NO in Step S2, and the processing advances to Step S3.

In Step S3, the CPU 101 executes movement control of the robot 11, etc. In other words, the CPU 101 controls the respective movement actions of the robot 11 and robot movement mechanism 14 so that the deviation calculated in the position deviation calculation processing of Step S1 becomes less than a fixed distance, as described above.

Thereafter, the processing returns to Step S1, and this and following processing is repeated. In other words, at least one among the robot 11 and the robot movement mechanism 14 makes movement actions under the movement control of the CPU 101 so that the deviation gradually decreases, by the loop processing of Steps S1 to S3 being repeated. The absolute position of the processing-machine leading end thereby approaches the absolute position of the aiming position 41.

Thereafter, since the deviation is less than a fixed distance when the absolute position of the processing-machine leading end substantially matches the absolute position of the aiming position 41, the CPU 101 determines that positioning has ended in Step S2, stops movement control, and notifies positioning end to the processing-machine control device 17. The processing thereby advances to Step S4.

In Step S4, the processing-machine control device 17 acquires information of the attitude, level differences, gaps, etc. of the processing target from the robot control device 16, and calculates processing conditions based on the acquired information.

In Step S5, the processing-machine control device 17 determines whether there are no problems with the processing conditions thus calculated in the processing of Step S4.

In a case of the processing machine 12 performing a processing action in accordance with the processing conditions calculated in the processing of Step S4 being inappropriate or the processing action being impossible, it is determined as being NO in Step S5, and the processing advances to Step S6.

In Step S6, the processing-machine control device 17 executes control of processing condition modification for the processing machine 12.

When the processing of Step S6 terminates, this fact is notified from the processing-machine control device 17 to the robot control device 16, whereby the processing is returned to Step S1, and this and following processing is repeated. In other words, since the workpiece 2 is being continuously conveyed by the continuous conveying mechanism 20 even during execution of the processing of Step S6, there is a possibility that the deviation of the absolute position of the processing-machine leading end relative to the absolute position of the aiming position 41 is increasing. Therefore, the respective movement control of the robot 11 and robot movement mechanism 14 is executed again by the loop processing of Steps S1 to S3 being repeatedly executed. Then, if the deviation becomes less than the fixed distance again, the processing conditions are re-calculated by the processing of Step S4. In a case of the processing machine 12 performing the processing action being inappropriate or the processing action being impossible still according to this processing condition, it is determined as being NO in Step S5, and the processing advances to Step S6.

By configuring in this way, when the appropriate processing conditions are calculated by the loop processing of Steps S1 to S6 being repeatedly executed, it is determined as being YES in Step S5, and the processing advances to Step S7.

In Step S7, the processing-machine control device 17 controls the processing action of the processing machine 12 on the processing target at the aiming position 41.

When the processing action by the processing machine 12 ends, this fact is notified from the processing-machine control device 17 to the robot control device 16, whereby the processing advances to Step S8.

In Step S8, the CPU 101 of the robot control device 16 determines whether to process another processing target.

In a case of processing another processing target, it is determined as being YES in Step S8, the processing is returned to Step S1, and this and following processing is repeated. In other words, the position of another objective becomes the aiming position 41, the respective movement actions of the robot 11 and robot movement mechanism 14 are performed by the loop processing of Step S1 to S8 being repeated, a result of which, when the leading end of the processing machine 12 moves to the aiming position 41, the processing action is performed by the processing machine 12.

When all processing targets are processed in this way, it is determined as NO in Step S8, and the processing process comes to an end.

Next, a detailed example of the position deviation calculation processing of Step S1 will be explained while referencing the flowchart of FIG. 5.

FIG. 5 is a flowchart showing an example of the detailed flow of the position deviation calculation processing.

In the illustration of FIG. 5, the executor of the processing handled by the robot control device 16 is set to be any one of the camera-absolute-position acquisition unit 51 to robot-position control unit 56 in FIG. 2, realized by the CPU 101 in FIG. 3.

In Step S11, the camera-absolute-position acquisition unit 51 acquires the camera absolute position detected by the remote position sensor 18r. The camera absolute position acquired in this way is provided to the aiming position calculation unit 53.

In Step S12, the processing target recognition unit 52 recognizes the camera coordinate value of the aiming position 41, attitude, level differences, gaps, etc. for the processing target, from within the captured image, based on image data output from the camera 13. Among such recognition results, the camera coordinate value of the aiming position 41 is provided to the aiming position calculation unit 53, and the attitude, level differences, gaps, etc. are provided to the processing-machine control device 17. It should be noted that the attitude, level differences, gaps, etc. are used in the processing of calculating processing conditions in Step S4, as described above.

In Step S13, the aiming position calculation unit 53 calculates the absolute position of the aiming position 41 for the processing target, using the camera absolute position acquired in the processing of Step S11, and the camera coordinate value of the aiming position 41 recognized in the processing of Step S12. The absolute position of the aiming position 41 calculated in this way is provided to the robot position control unit 56.

In Step S14, the arm-absolute-position acquisition unit 54 acquires the arm absolute position detected by the remote position sensor 19r. The arm absolute position acquired in this way is provided to the processing-machine leading-end absolute position calculation unit 55.

In Step S15, the processing-machine leading-end absolute position calculation unit 55 calculates the absolute position of the processing-machine leading end, based on the arm absolute position acquired in the processing of Step S14. The absolute position of the processing-machine leading end calculated in this way is provided to the robot position control unit 56.

It should be noted that the processing of Steps S11 to S13 and the processing of Steps S14 and S15 are independent processes from each other in actual practice; therefore, the order of this processing is not particularly limited to the example of FIG. 5. In other words, the processing of Steps S11 to S13 and the processing of Steps S14 and S15 can also be executed almost simultaneously in parallel. Alternatively, the processing of Steps S11 to S13 can be executed after the processing of Steps S14 and S15. In either case, when the absolute position of the aiming position 41 and the absolute position of the processing-machine leading end are provided to the robot position control unit 56, the processing advances to Step S16.

In Step S16, the robot position control unit 56 calculates the deviation of the absolute position of the processing-machine leading end calculated in the processing of Step S15 relative to the absolute position of the aiming position 41 calculated in the processing of Step S13.

The position deviation calculation processing thereby ends, i.e. Step S1 in FIG. 4 ends, and the processing advances to Step S2. As described above, in a case of the deviation calculated by such position deviation calculation processing being at least a fixed distance, it is determined as being NO in Step S2, the processing advances to Step S3, and this and following processing is executed. In other words, by the loop processing of Steps S1 to S3 being repeated until the deviation becomes less than the fixed distance, at least one among the robot 11 and robot movement mechanism 14 makes movement actions under the movement control of the CPU 101, so that the deviation gradually decreases.

There are the following such effects according to the present embodiment.

(1) Since the robot base 22 can be made to move by the robot movement mechanism 14, the necessity of specially providing a processing area for decoupling the workpiece 2 from continuous conveyance and allowing to temporarily stop is eliminated. Furthermore, since the robot movement mechanism 14 can cause the robot base 22 to move independently from the continuous conveyance of the workpiece 2 by the continuous conveying mechanism 20, the necessity for synchronizing the movements of the robot base 22 and workpiece 2 is eliminated in particular.

The mechanical costs that have been conventionally required as production costs of a production line 1 of the workpieces 2, e.g., the mechanical cost for decoupling the workpiece 2 from continuous conveyance, and the mechanical cost for making the workpiece 2 and robot base 22 both move synchronously, thereby become unnecessary. Therefore, it becomes possible to realize a processing line of the workpieces 2 with low cost compared to conventionally.

In addition, by combining the movement control of the robot 11 (movement control of arm 23) and movement control of the robot movement mechanism 14 (movement control of robot base 22), it is possible to make the leading end of the processing machine 12 move towards the aiming position 41 of the workpiece 2. Therefore, compared with conventionally, the operating range of one robot 11 expands; therefore, the degrees of freedom in processing actions of the processing machine 12 connected to one robot 11 improve, and it becomes possible to perform more efficient processing than conventionally.

(2) The deviation used in movement control of the arm 23 is calculated in the world coordinate system, based on the observation information in the vicinity of the leading end of the processing machine 12 or in the vicinity of the aiming position 41 (detection results of remote position sensors 18r, 19r). This means that the deviation used in movement control of the arm 23 can be obtained without dependence on the position of the robot base 22.

Therefore, it becomes possible for the robot control device 16 to appropriately execute positioning control to make the leading end of the processing machine 12 match the objective aiming position 41, at whatever position the robot base 22 is present.

(3) The position of the leading end of the processing machine 12 can theoretically be obtained in robot coordinate system using the feedback value of movement control of the arm 23. Therefore, it is possible to obtain the absolute position of the processing-machine leading end, by converting the position of the leading end of the processing machine 12 obtained in the robot coordinate system into the world coordinate system.

However, in the absolute position of the processing-machine leading end obtained in this way, error arises based on the error causes indicated in the following (a) to (d), for example.

(a) bending of the arm 23 due to gravity

(b) vibration of the arm 23

(c) expansion and contraction of each component of the arm 23 due to temperature changes

(d) shifting of the arm 23 relative to the design value, occurring due to rattling and loosening of fasteners, etc.

Therefore, a technique currently exists of correcting these error causes (a) to (d) in order to eliminate the error in the absolute position of the processing-machine leading end. However, this technique is not omnipotent, and complete elimination of error is not guaranteed. In addition, in a case of adopting this technique, there is a necessity to perform complex calculations until obtaining the absolute position of the processing-machine leading end, a result of which the entire processing system becomes complex, and difficult to handle.

In contrast, with the present embodiment, the arm absolute position is directly acquired by the remote position sensor 19r provided in a prescribed manner remotely to the robot 11, and the absolute position of the processing-machine leading end is obtained based on this arm absolute position. This arm absolute position is a measured position having all of the error causes (a) to (d), and the calculations to correct the error causes (a) to (d) such as of the aforementioned conventional technique is unnecessary. Therefore, with the present embodiment, when comparing with this conventional technique, the calculations until obtaining the absolute position of the processing-machine leading end are simpler, a result of which it is possible to make the overall processing system 1 in a simpler configuration.

(4) The absolute position of the aiming position 41 can theoretically be obtained using position commands and speed commands for the continuous conveying mechanism 20, CAD data of the workpiece 2, and the like. However, in the absolute position of the aiming position 41 obtained in this way, errors arise based on the error causes indicated by the following (A) to (C), for example.

(A) vibrations in the progression of the workpiece 2 continuously conveyed by the continuous conveying mechanism 20 (each of the vertical, left-right, and front-back directions)

(B) installed form of the continuous conveying mechanism 20 inclining and curving horizontally

(C) individual differences in the shapes and positions of workpieces 2

Therefore, it has been necessary to fundamentally remove these error causes (A) to (C) in order to eliminate the error in the absolute position of the aiming position 41. In other words, it is necessary to manufacture the continuous conveying mechanism 20 with high precision in order to remove the error causes (A) and (B). However, enormous cost would be incurred in the manufacture of such a high precision continuous conveying mechanism 20, and is not realistic. In addition, raising the precision of the workpiece 2 is necessary in order to remove the error cause (C). However, raising the precision of the workpiece 2 is not realized by an improvement in a specific manufacturing process, but rather improvements in the overall manufacturing process related to the construction of the workpiece 2 are necessary, and thus enormous cost would be incurred for these improvements, and a long time period would be required until realization.

In contrast, with the present embodiment, the camera coordinate value of the aiming position 41 can be obtained from the captured image of the camera 13, which functions as a measurement sensor mounted to the robot 11. In addition, the camera absolute position is directly acquired by the remote position sensor 18r provided in a prescribed manner at a remote position to the robot 11. Then, the absolute position of the aiming position 41 is obtained based on the camera coordinate value of the aiming position 41 and the camera absolute position. This camera absolute position is a measured position including all of the error causes (A) to (C), and thus raising the precision of the continuous conveying mechanism 20 and workpiece 2 becomes unnecessary in particular. Therefore, with the present embodiment, it is possible to realize the entire processing system 1 with low cost, compared to a case of raising the precision of the continuous conveying mechanism 20 and workpiece 2.

It should be noted that the present invention is not limited to the present embodiment, and that modifications, improvements, etc. within a scope that can achieve the object of the present invention are included in the present invention.

For example, visual servo control using the absolute position of the processing-machine leading end obtained from the captured image of the camera 13 as feedback information is adopted in the present embodiment as the movement control technique of the robot 11 (arm 23). However, the movement control technique of the robot 11 is not particularly limited to the present embodiment, and it is possible to adopt various control techniques using the aforementioned deviation.

In addition, although the remote position sensor 19r is provided as the sensor for obtaining the absolute position of the processing-machine leading end, and the detection object 19s used as a pair with this remote position sensor 19r is mounted to the connection member 32e of the arm 23 in the present embodiment, it is not particularly limited thereto.

For example, the mounting position of the detection object 19s may be any position so long as being a position enabling measurement including the aforementioned error causes (a) to (d). For example, in regards to the processing machine 12 itself, since the similar error causes as the aforementioned error causes (a) to (d) can be present albeit slight, it is preferable to mount the detection object 19s to the processing machine 12 if possible. This is because it is possible to much more accurately obtain the absolute position of the processing-machine leading end than the present embodiment.

In addition, a sensor that does not measure the position of the detection object 19s, but rather can directly measure the position of the leading end of the processing machine 12 may be employed in place of the remote position sensor 19r.

Similarly, although the remote position sensor 18r is provided as the sensor for obtaining the camera absolute position, and the detection object 18s used as a pair with this remote position sensor 18r is mounted to the camera 13 in the present embodiment, it is not particularly limited thereto. For example, a sensor that does not measure the position of the detection object 18s, but rather can directly measure the position of the camera 13 may be employed in place of the remote position sensor 18r.

Alternatively, a remote position sensor capable of detecting at least two detection objects may be employed, and the camera absolute position, as well as the arm absolute position or the absolute position of the processing-machine leading end may be detected with one of these remote position sensors.

In short, it only needs to be a sensor that can obtain the deviation of the absolute position of the processing-machine leading end relative to the absolute position of the aiming position 41, the sensor being installed to be separated from the robot 11, and able to detect one position of any among the processing machine 12, robot 11 and camera 13.

In addition, although the camera 13 is provided as a sensor for measuring the position and attitude of the aiming position 41 in the present embodiment, for example, it is not particularly limited thereto. In other words, it is sufficient to be a sensor that is provided in a prescribed manner to the processing machine 12 or robot 11, and can detect the position and attitude of the aiming position 41.

In addition, although the movement direction of the robot movement mechanism 14 is defined as a horizontal direction to the movement direction of the workpiece 2 by the continuous conveying mechanism 20 in the example of FIG. 1, for example, it is not particularly limited thereto, and may be defined as any direction (three-dimensional direction) of the world coordinate system completely independently from the movement direction of the workpiece 2 by the continuous conveying mechanism 20.

Furthermore, although an embodiment configuring the camera-absolute-position acquisition unit 51 to robot-position control unit 56 of FIG. 2 by a combination of software and hardware (relevant parts including CPU 101) has been explained in the present embodiment, this configuration is understandably an exemplification, and the present invention is not limited thereto. For example, at least one part of the camera-absolute-position acquisition unit 51 to robot-position control unit 56 may be configured by dedicated hardware or configured by software.

In this way, the sequence of processing according to the present invention can be made to be executed by software, or made to be executed by hardware.

In a case of having the sequence of processing executed by software, a program constituting this software can be installed via a network, or from a recording medium, to a computer or the like. The computer may be a computer incorporating dedicated hardware, or may be a general-use personal computer, for example, that can execute various functions by installing various programs.

The recording medium including various programs for executing the sequence of processing according to the present invention may be removable media distributed separately from the information processing device (e.g., robot control device 16 in the present embodiment) main body in order to provide programs to the user, or may be a recording medium or the like incorporated into the information processing device main body in advance. The removable media is configured by magnetic disks (including floppy disks), optical disks, magneto-optical disks, or the like, for example. The optical disk is configured by a CD-ROM (Compact Disk-Read Only Memory), DVD (Digital Versatile Disk), or the like, for example. The magneto-optical disk is configured by an MD (Mini-Disk), or the like. In addition, as the recording medium incorporated into the device main body in advance, it may be the ROM 102 of FIG. 5, a hard disk included in the storage unit 108 of FIG. 5, or the like on which a program is recorded.

It should be noted that the steps describing the program recorded in the recording medium naturally include processing performed chronologically in this order, but is not necessarily processed chronologically, and also includes processing executed in parallel or separately.

In addition, the system in the present disclosure expresses the overall device configured by a plurality of devices and processing units.

1. A processing system that performs predetermined processing on a workpiece that is continuously conveyed, comprising:
a continuous conveying mechanism that causes the workpiece to be continuously conveyed;
a processing device that performs a predetermined processing action on the workpiece;
a base to which the processing device is mounted;
a movement mechanism to which the base is mounted, and causing the base to move; and
a control device that executes, as movement control on the movement mechanism, control to cause the base to move independently from continuous conveyance of the workpiece by way of the continuous conveying mechanism.

2. A processing system according to claim 1, further comprising:
a first detection sensor that is disposed at the processing device, and at least detects a position of a processing target of the workpiece; and
a second detection sensor that is disposed to be separated from the processing device, and detects a position of either of the processing device or the first detection sensor,
wherein the control device further
obtains deviation of an absolute position of a leading end of the processing device relative to an absolute position of the processing target, using detection results of each of the first detection sensor and the second detection sensor, and
controls movement action of the processing device based on the deviation.

3. A processing method for performing predetermined processing on a workpiece that is continuously conveyed by way of a continuous conveying mechanism, comprising
a control device, which executes movement control of a base to which a processing device that processes the workpiece is mounted,
executing control to cause the base to move independently from continuous conveyance of the workpiece by the continuous conveying mechanism.

4. A processing method according to claim 3, wherein the control device further:
obtains deviation of an absolute position of a leading end of the processing device relative to an absolute position of a processing target of the workpiece, using a detection result of a first detection sensor that is disposed at the processing device and at least detects a position of the processing target, and
a detection result of a second detection sensor that is disposed to be separated from the processing device and detects a position of either the processing device or the first detection sensor; and
controls movement action of the processing device based on the deviation.
